(19) United States
(12) Patent Application Publication
(10) Pub. No.: US 2012/0039589 A1
(43) Pub. Date: Feb. 16, 2012

(54) IMAGE STABILIZATION SYSTEM

(75) Inventors: PING-HAN KU, Tu-Cheng (TW); SHUN-FAN CHIANG, Tu-Cheng (TW)

(73) Assignee: HON HAI PRECISION INDUSTRY CO., LTD., Tu-Cheng (TW)

(21) Appl. No.: 12/967,052

(22) Filed: Dec. 14, 2010

(30) Foreign Application Priority Data
Aug. 12, 2010 (TW) 99126848

(51) Int. Cl. G03B 17/00

(52) U.S. Cl. 396/55

(57) ABSTRACT

A stabilization system includes a camera module, a fixed body, a movable frame, a pivot member, a motion sensor, a magnetic driving module, and an electric member. The movable frame receives the camera module and includes a first outer surface, a second outer surface, a third outer surface and a fourth outer surface. The motion sensor is attached to the fourth outer surface. The driving module includes a first magnetic driving unit arranged on the fixed body and a second magnetic driving unit arranged on the first, second, and third outer surfaces. The driving module drives the movable frame to rotate around the pivot member to compensate a movement of the camera module based on a motion detection result of the motion sensor through interaction between the first and second magnetic driving units. The electric member interconnects the fixed body and the movable frame.

### BACKGROUND

1. Technical Field

The present disclosure relates to camera systems, and particularly to an image stabilization system.

2. Description of Related Art

In normal use of a camera, light rays from an object transmit into the camera and fall on a particular region of an image sensor. The image sensor forms an optical image associated with the object at a first position.

However, camera-shake is common during hand-held shooting. Consequently, light rays from the object may fall on a different region of the image sensor resulting in a blurry image. Current image stabilization systems that deal with this problem are expensive and complicated.

Therefore, a new image stabilization system is desired to overcome the above-mentioned problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an image stabilization system according to an exemplary embodiment.

FIG. 2 is an exploded, isometric view of the stabilizing system of FIG. 1.

FIG. 3 is a cross-sectional view of the stabilization system of FIG. 1, taken along a line III-III thereof.

FIG. 4 is a cross-sectional view of the stabilization system of FIG. 1, taken along a line IV-IV thereof.

FIG. 5 is a block diagram showing a relationship between a motion sensor, a control circuit, and a first magnetic driving unit of the stabilization system of FIG. 1.

### DETAILED DESCRIPTION

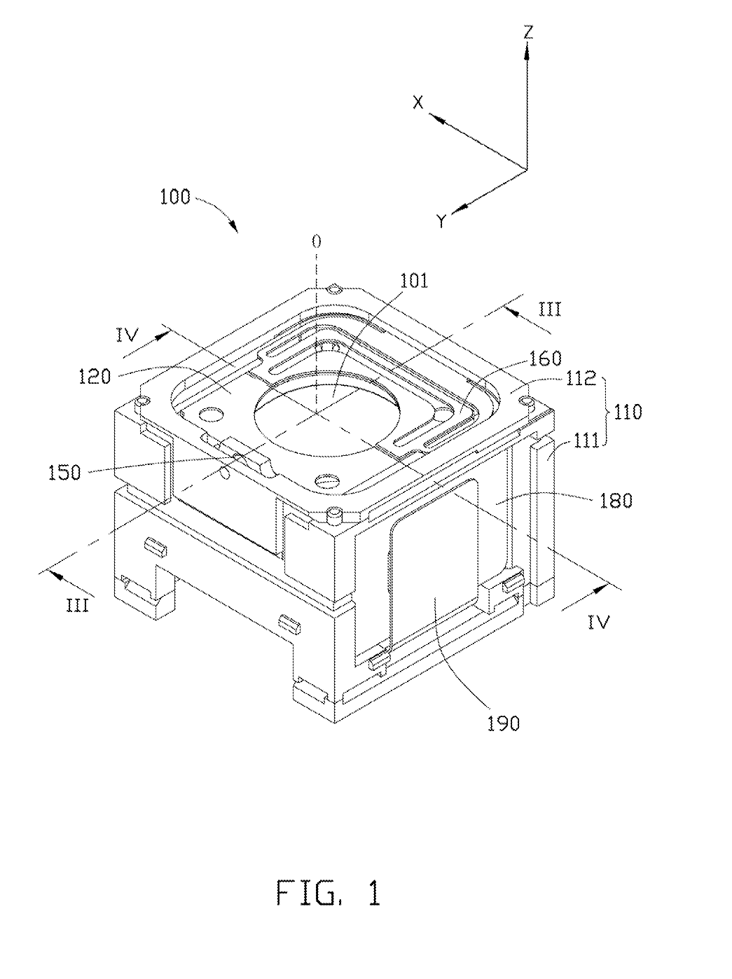

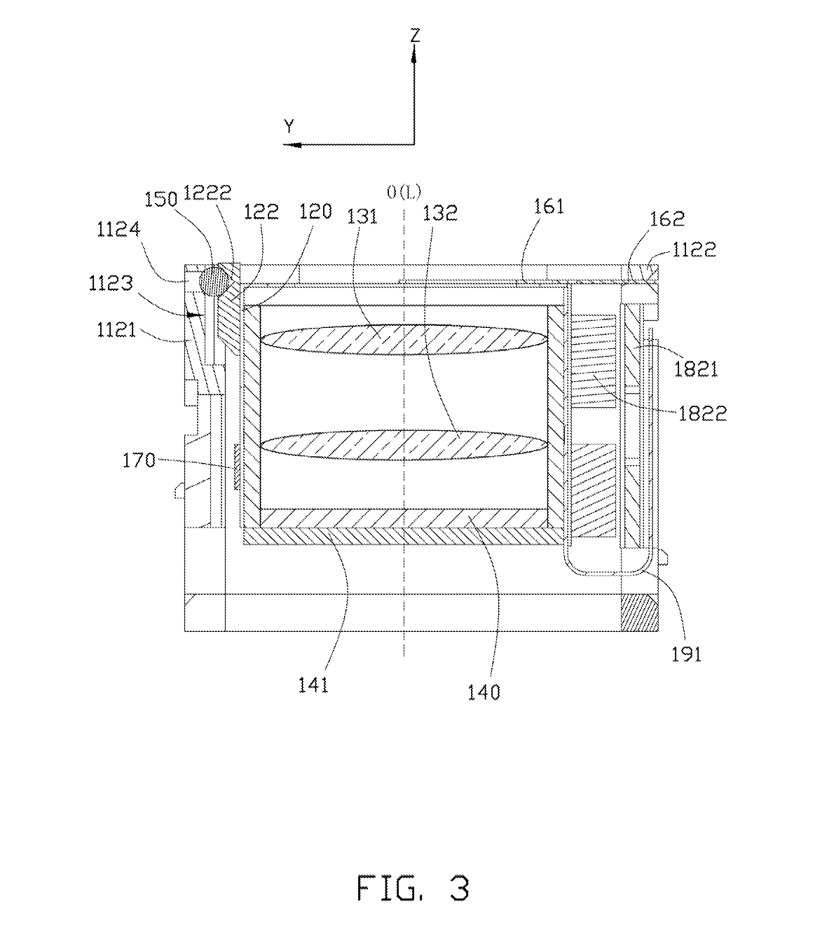

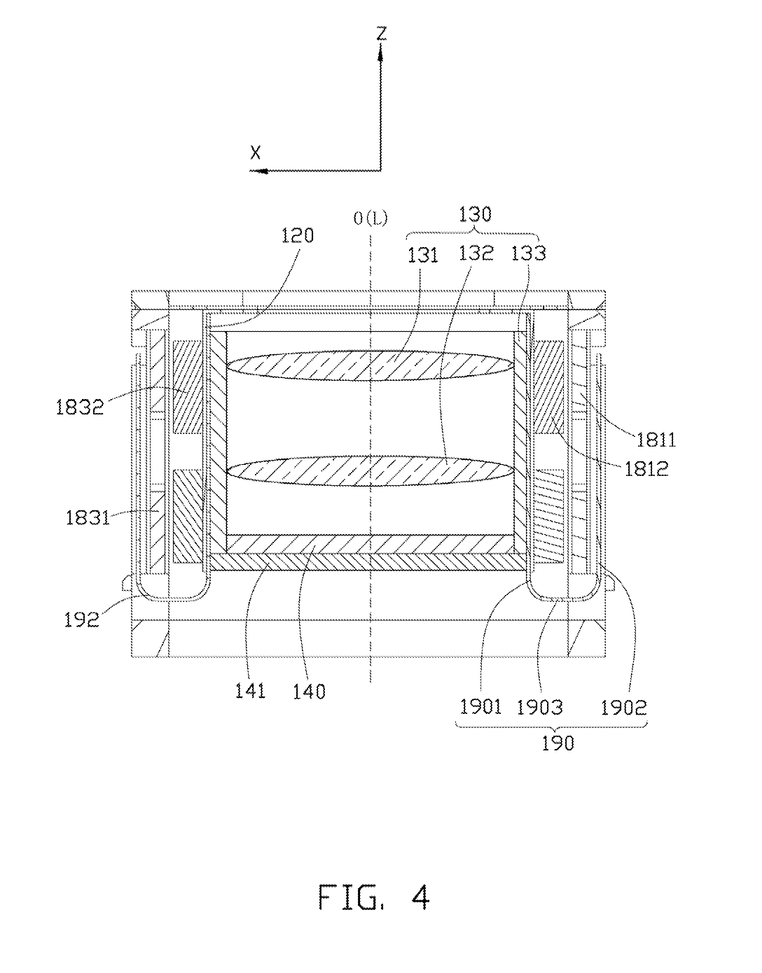

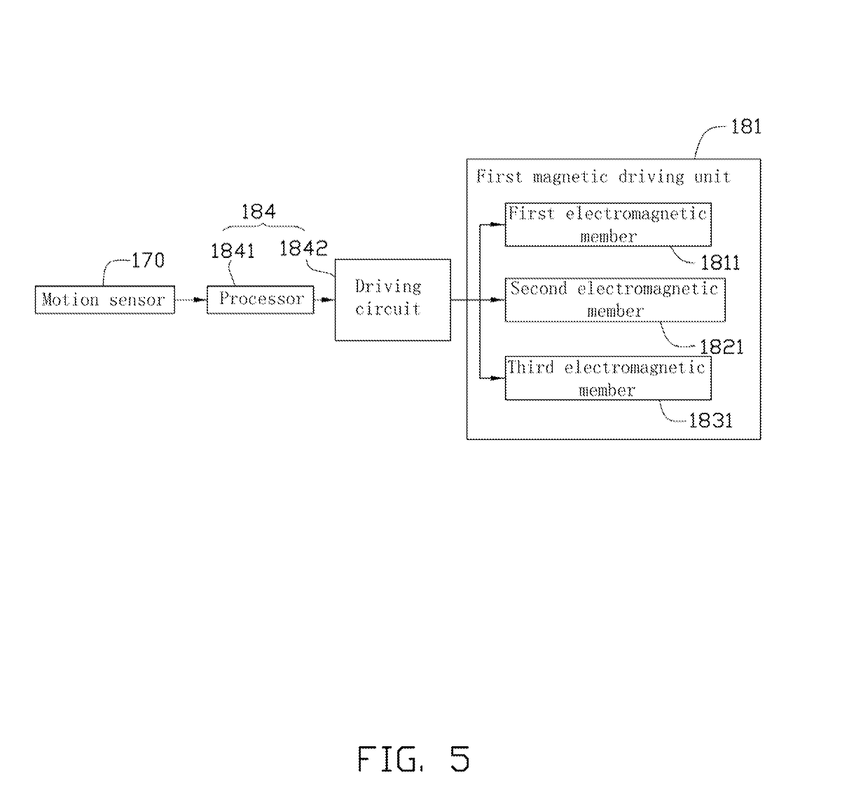

Referring to FIGS. 1-5, an image stabilization system 100, in accordance with an exemplary embodiment, is shown. The system 100 includes a camera module 101, a fixed body 110, a movable frame 120, a pivot member 150, an elastic member 160, a motion sensor 170, a magnetic driving module 180, and a magnetic shield unit 19 made of material having very high permeability to magnetic field. The camera module 101 has an optical axis O.

The fixed body 110 is substantially cubic. The fixed body 110 is securely mounted on a main body of an electronic device (not shown) using the system 100. The fixed body 110 includes a main frame 111 and an attachable frame 112.

The main frame 111 is substantially cubic, and includes a first sidewall 1111, a second sidewall 1112, a third sidewall 1113 opposite to the first sidewall 1111, and a fourth sidewall 1114 opposite to the second sidewall 1112. The first sidewall 1111 is parallel to the third sidewall 1113 and is perpendicular to the second sidewall 1112. The second sidewall 1112 is parallel to the fourth sidewall 1114. The four sidewalls 1111, 1112, 1113, and 1114 cooperatively define a first receiving cavity 1115 for receiving the movable frame 120. The first sidewall 1111 defines a first receiving hole 1116 at the center thereof. The second sidewall 1112 defines a second receiving hole 1117 at the center thereof. The third sidewall 1113 defines a third receiving hole 1118 at the center thereof. An upper end surface of the fourth sidewall 1114 defines a first receiving recess 1119 for receiving the attachable frame 112. In other embodiments, the main frame 111 may instead be any other suitable shape, such as cylindrical, pentagonal prismatic etc. In this embodiment, an X axis is defined along a direction perpendicular to the first sidewall 1111, and a Y axis is defined along a direction perpendicular to the second sidewall 1112 and a Z axis is defined along a direction parallel to a central line H of the main frame 111. The Z axis is perpendicular to the X axis and the Y axis.

The attachable frame 112 is substantially L-shaped. The attachable frame 112 is configured for partially receiving the pivot member 150, and conveniently fixing the elastic member 160 on the main frame 111. The attachable frame 112 includes a plate 1121, and a square frame 1122 perpendicular to the plate 1121. The plate 1121 is securely mounted in the first receiving recess 1119. The plate 1121 has an inner surface 1123 in the first receiving cavity 1115. The inner surface 1123 defines a first receiving portion 1124 for partially receiving the pivot member 150 therein. The square frame 1122 is securely mounted on the top surfaces of the first, second, and third sidewalls 1111, 1112, and 1113. In the present embodiment, the first receiving portion 1124 is a round through hole having a diameter less than that of the pivot member 150. In alternative embodiments, the first receiving portion 1124 may be a recess. In other alternative embodiments, the pivot member 150 may instead be partially received in the fourth sidewall 1114. In such case, the recess 1119 and the plate 1121 may be omitted.

The movable frame 120 is substantially cubic, and is received in the first receiving cavity 1115. The movable frame 120 is configured for securely receiving the camera module 101 therein. The movable frame 120 is substantially cubic, and includes a first outer surface 1211, a second outer surface 1212, a third outer surface 1213, a fourth outer surface 1214, and a top surface 1215. The first outer surface 1211, the second outer surface 1212, the third outer surface 1213, and the fourth outer surface 1214 are parallel to the optical axis O of the camera module 101. The top surface 1215 is substantially perpendicular to the optical axis O of the camera module 101. The top surface 1215 is substantially square, and is perpendicular to the four outer surfaces 1211, 1212, 1213, and 1214. The four outer surfaces 1211, 1212, 1213, and 1214 and the top plate 1215 cooperatively define a second receiving cavity 1216 for securely receiving the camera module 101. The first outer surface 1211 faces the first sidewall 1111. The second outer surface 1212 faces the second sidewall 1112. The third outer surface 1213 faces the third sidewall 1113. The fourth outer surface 1214 faces the fourth sidewall 1114. A central axis L of the movable frame 120 coincides with the optical axis O of the camera module 101. When the system 100 stays still, the central axis H of the main frame 111 coincides with the optical axis O of the camera module 101 and the central axis L of the movable frame 120. That is, when the system 100 stays still, the main frame 111 is coaxial to the movable frame 120 and the camera module 101.

The top surface 1215 defines a through hole 1217 at the center thereof. The through hole 1217 allows light to pass through the top surface 1215 to reach the camera module 101. In other embodiments, the movable frame 120 may instead be any other suitable shape, such as cylindrical, pentagonal prismatic etc.

The system 100 further includes a receiving member 122. The receiving member 122 is configured for partially receiving the pivot member 150, thereby engaging with the attachable frame 112 for receiving the pivot member 150. In this embodiment, the receiving member 122 is securely mounted on the fourth outer surface 1214 and is spaced from the plate 1121. The receiving member 122 has an outer surface 1221 facing the inner surface 1123. The outer surface 1221 defines a second receiving portion 1222 for partially receiving the pivot member 150. In the present embodiment, the second receiving portion 1222 is a recess. In other embodiments, the second receiving portion 1222 may be a round through hole. In a further embodiment, the receiving member 122 may be omitted. In such case, the pivot member 150 can be partially received in the fourth outer surface 1214 therein.

The camera module 101 is securely mounted in the movable frame 120. The camera module 101 includes a lens module 130, an image sensor 140 and a circuit board 141.

The lens module 130 includes a first lens 131, a second lens 132 and a barrel 133 receiving the first and second lenses 131, 132. The lens module 130 has an optical axis coinciding with the optical axis O of the camera module 101. In alternative embodiments, the camera module 101 may further include an actuator for moving the first lens 131 and/or the second lens 132 to achieve focusing and/or zooming of the camera module 101.

The image sensor 140 is electrically connected and securely mounted to the circuit board 141. The image sensor 140 is located at the image side of the lens module 130. The circuit board 141 is securely mounted on the bottom end of the barrel 133. The image sensor 140 is surrounded by the movable frame 120 in this embodiment. The image sensor 140 is configured for converting an optical image to an electrical signal.

The pivot member 150 is engagingly received in and between the first receiving portion 1124 and the second receiving portion 1222, such that the movable frame 120 together with the camera module 101, driven by the driving module 180, can rotate around the pivot member 150 relative to the main frame 111. In the present embodiment, the pivot member 150 is a rolling ball, and the movable frame 120 and the camera module 101 can rotate around both the X axis and Y axis. In other embodiments, the pivot member 150 may instead be a shaft, such that the movable frame 120 can only rotate around the X axis, or only rotate around the Y axis.

The elastic member 160 is configured for providing an elastic restoring force to make the movable frame 120 coaxial to the main frame 111. The elastic member 160 is arranged between the main frame 111 and the attachable frame 112. The elastic member 160 includes a first fixed portion 161, a second fixed portion 162, and an elastic connecting portion 163 connecting the first fixed portion 161 to the second fixed portion 162. The first fixed portion 161 is, for example, adhesively mounted on the top surface 1215. The second fixed portion 162 is securely mounted on the first sidewall 1111, the second sidewall 1112, and the third sidewall 1113, thereby interposing the elastic connecting portion 163 between the fixed body 110 and the movable frame 120. In alternative embodiments, the second fixed portion 162 may instead be secured on the square frame 1122. In other alternative embodiments, the elastic member 160 may instead be a spring. In such case, the number of the elastic member 160 may be two, three, and so on.

The motion sensor 170 is securely mounted on the fourth outer surface 1214, and is configured for sensing movement of the camera module 101 (i.e., movement of the movable frame 120). In such arrangement, the system 100 is compact. The motion sensor 170 can be a gyro sensor.

The driving module 180 is configured for driving the camera module 101 (i.e., the movable frame 120) to move relative to the main frame 111 to compensate for movements of the camera module 101 based on/associated with a motion detection result/signals of the motion sensor 170, thereby eliminating/reducing blur due to camera shake. The driving module 180 includes a first magnetic driving unit 181, a second magnetic driving unit 182, and a control circuit 184. The first magnetic driving unit 181 is arranged on the fixed body 110. The second magnetic driving unit 182 is arranged on the first, second and third outer surfaces 1211, 1212, and 1213. The first magnetic driving unit 181 and the second magnetic driving unit 182 interact with each other to drive the movable frame 120 and the camera module 101 to rotate round the pivot member 150 relative to the fixed body 110.

In this embodiment, the first magnetic driving unit 181 includes three electromagnetic members 1811, 1821, 1831 (e.g., coils, hereinafter a first electromagnetic member 1811, a second electromagnetic member 1821 and a third electromagnetic member 1831). Each electromagnetic member is substantially a rectangular ring and includes an upper portion and a lower portion. For example, the first electromagnetic member 1811 includes an upper portion 1813 and a lower portion 1814. The first electromagnetic member 1811 is received in the first through hole 1116. The second electromagnetic member 1821 is received in the second through hole 1117. The third electromagnetic member 1831 is received in the third through hole 1118.

The second magnetic driving unit 182 includes three magnet units 1812, 1822, and 1832 (hereinafter a first magnet unit 1812, a second magnet unit 1822, and a third magnet unit 1832). Each magnet unit is securely attached to a corresponding outer surface of the movable frame 120 and faces a corresponding electromagnetic member to interact with the corresponding electromagnetic member to generate a driving force. That is, the first magnet unit 1812 is positioned on the first outer surface 1211 and faces the first electromagnetic member 1811. The second magnet unit 1822 is positioned on the second outer surface 1212 and faces the second electromagnetic member 1821. The third magnet unit 1832 is positioned on the third outer surface 1213 and faces the third electromagnetic member 1831.

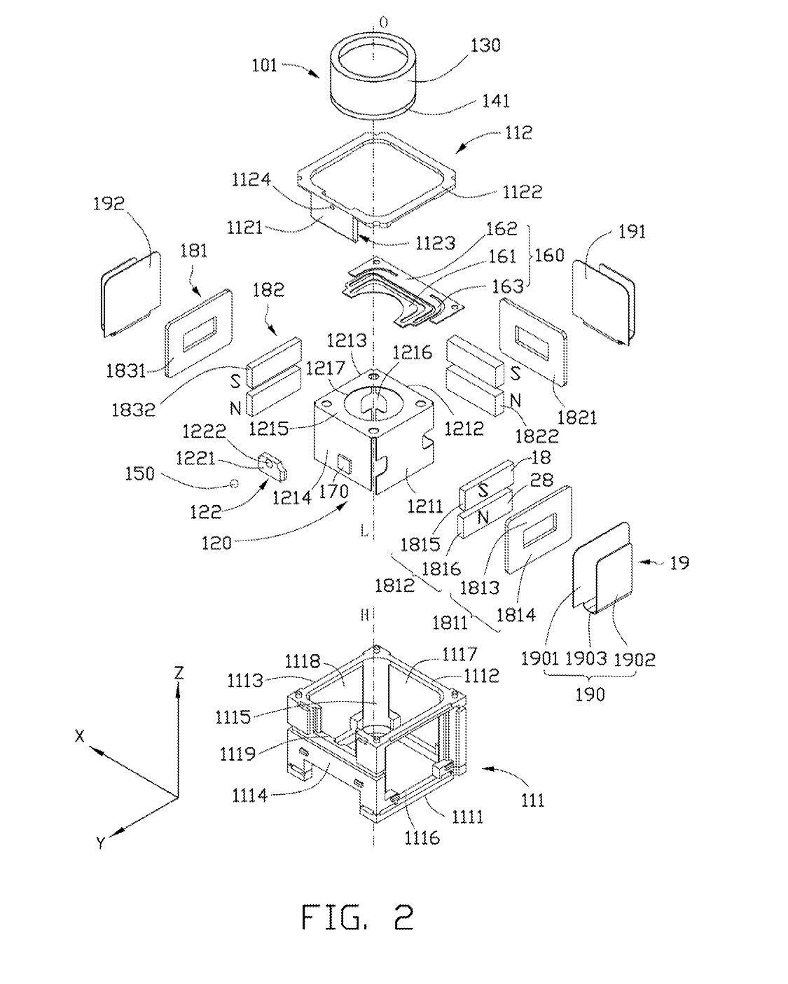

Each magnet unit includes an upper magnet and a lower magnet. A magnetic pole of the upper magnet facing a corresponding electromagnetic member is opposite to a magnetic pole of the lower magnet facing the corresponding electromagnetic member. For example, the first magnet unit 1812 includes an upper magnet 1815 spatially corresponding to the upper portion 1813, and a lower magnet 1816 spatially corresponding to the lower portion 1814. A first magnetic pole 18 of the upper magnet 1815 facing the first electromagnetic member 1811 is opposite to a second magnetic pole 28 of the lower magnet 1816 facing the first electromagnetic member 1811. In this embodiment, the first magnetic pole 18 is magnetic south, and the second magnetic pole 28 is magnetic north, as shown in FIG. 2.

The control circuit 184 is electrically connected to the first magnetic driving unit 181. The control circuit 184 includes a processor 1841 and a driving circuit 1842 electrically connected to the processor 1841. The processor 1841 is electrically connected to the motion sensor 170. The driving circuit 1842 is electrically connected to the first electromagnetic member 1811, the second electromagnetic member 1821 and the third electromagnetic member 1831. The processor 1841 can be, for example, a digital signal processor (DSP) position controller.

The magnet shield unit 19 includes three U-shaped magnetic shields 190, 191, 192 (hereinafter a first magnetic shield 190, a second magnetic shield 191, and a third magnetic shield 192).

The first magnetic shield 190 is configured for enhancing magnetic fields of the first electromagnetic member 1811 and the first magnet unit 1812, and preventing the magnetic fields from interfering with the normal operation of the camera module 101, such as the image sensor 140. In the present embodiment, the first magnetic shield 190 is made of ferronickel alloy. In alternative embodiments, the first magnetic shield 190 may instead be made of any other magnetically permeable material, such as electrically conductive polymer, surface conductive material, electrically conductive glass, etc.

The first magnetic shield 190 includes a first plate 1901, a second plate 1902 opposite to the first plate 1901, and a connecting plate 1903 perpendicularly connected the first plate 1901 and the second plate 1902. The first plate 1901 is securely mounted on the movable frame 120. The second plate 1902 is located on an opposite side of the first plate 1901 to the fixed body 110 such that the first electromagnetic member 1811 and the first magnet unit 1812 are arranged between the first plate 1901 and the second plate 1902. In the present embodiment, the first plate 1901 is securely mounted on an inner surface of the movable frame 120, and the second plate 1902 is away from an outer surface of the first sidewall 1111. Thus, from the inside to the outside, the first plate 1901, the first outer surface 1211, the first magnet unit 1812, the first electromagnetic member 1811, and the second plate 1902 are arranged in that order.

The second magnetic shield 191 is similar to the first magnetic shield 190, and is configured for enhancing magnetic fields of the second electromagnetic member 1821 and the second magnet unit 1822, and preventing the magnetic fields from interfering with the normal operation of the camera module 101.

The third magnetic shield 192 is similar to the first magnetic shield 190, and is configured for enhancing magnetic fields of the third electromagnetic member 1831 and the third magnet unit 1832, and preventing the magnetic fields from interfering with the normal operation of the camera module 101.

In operation, at the beginning of capturing an image with the system 100, the elastic members 160 are in a normal state and the movable frame 120 is coaxial to the main frame 111; and there is no power supplied to the first electromagnetic member 1811, a second electromagnetic member 1821, and the third electromagnetic member 1831. At this moment, the system 100 forms an image associated with an object (not shown) on a first position of the image sensor 140.

During image capture, camera shake may cause, for example, the system 100 to rotate clockwise around the Y axis relative to the object. Accordingly, the camera module 101 is rotated with the system 100. The motion sensor 170 detects a movement of the camera module 101 and sends a motion detection result to the processor 1841. Based on the motion detection result, the processor 1841 computes a compensating adjustment for the camera module 101 in order to reposition the image on the first position of the image sensor 140. For example, the computed compensating angle may require the camera module 101 to rotate anti-clockwise around the Y axis a certain degree. The processor 1841 then sends a signal to the driving circuit 1842, and the driving circuit 1842 applies power to the first electromagnetic member 1811 in response to the signal, such that the first magnet unit 1812 (i.e. the movable frame 120), is driven by magnetic force to rotate clockwise around the Y axis.

Hence, the movable frame 120 together with the camera module 101 is rotated anti-clockwise the predetermined angle around the Y axis, and the elastic connecting portion 163 becomes stretched. As a result, the system 100 forms an image associated with the object (not shown) on the first position of the image sensor 140 and camera shake is compensated for. In addition, the driving module 180 of the system 100 applies magnetic forces to drive the movable frame 120 to rotate around the pivot member 150, and the control of the magnetic forces is easier. Therefore, the driving module 180 is simpler, and the system 100 is accordingly simpler, too. Therefore, the cost of the system 100 is lower.

After capturing the stabilized image of the object, even though the driving circuit 1842 may stop supplying power to the first electromagnetic member 1811, the elastic restoring forces generated by the deformation of the elastic connecting portion 163 can drive the movable frame 120 to be coaxial to the main frame 111 again.

It is to be understood that when the system 10 shakes, the system 100 may be only rotated around the X axis. In such circumstances, the second electromagnetic member 1821 should and can be activated to adjust the position of the movable frame 120 and the camera module 101.

It is also to be understood that when the system 10 shakes, the system 100 may be rotated around both the X axis and the Y axis. In these circumstances, the first electromagnetic member 1811, a second electromagnetic member 1821, and the third electromagnetic member 1831 may be activated to adjust a position of the movable frame 120 and the camera module 101.

It is to be understood that in alternative embodiments, the first magnetic pole may be magnetic north, and the second magnetic pole may be magnetic south. The first magnetic driving unit 181 may include magnet units and the second magnetic driving unit 182 may include electromagnetic members. In such case, the control circuit 184 is electrically connected to the second magnetic driving unit 182.

While certain embodiments have been described and exemplified above, various other embodiments will be apparent to those skilled in the art from the foregoing disclosure. The disclosure is not limited to the particular embodiments described and exemplified but is capable of considerable variation and modification without departure from the scope and spirit of the appended claims.

What is claimed is:

1. An image stabilization system comprising:
a camera module having an optical axis;
a fixed body;
a movable frame moveably received in the fixed body and spaced from the fixed body, the movable frame securely receiving the camera module and comprising a first outer surface, a second outer surface, a third outer surface opposite to the first outer surface and a fourth outer surface opposite to the second outer surface, wherein the first outer surface, the second outer surface, the third outer surface and the fourth outer surface are parallel with the optical axis;
a pivot member positioned between the fixed body and the movable frame;
a motion sensor attached to the fourth outer surface and configured for detecting a movement of the movable frame and the camera module;
a magnetic driving module comprising a first magnetic driving unit arranged on the fixed body and a second magnetic driving unit arranged on the first, second, and third outer surfaces, the magnetic driving module configured for driving the movable frame to rotate around the pivot member to compensate a movement of the camera module based on a motion detection result of the motion sensor through interaction between the first magnetic driving unit and the second magnetic driving unit; and
an electric member interconnecting the fixed body and the movable frame and configured for providing an elastic restoring force.

2. The image stabilization system of claim 1, further comprising a magnetic shield unit, the magnetic shield unit comprising three U-shaped magnetic shields each comprising a first plate, a second plate opposite to the first plate, and a connecting plate connecting the first plate and the second plate, the first plate being securely mounted on the movable frame, the second plate being located on an opposite side of the first plate to the fixed body, the driving module arranged between the first plate and the second plate.

3. The image stabilization system of claim 1, wherein the pivot member comprises a ball, or a rotation shaft.

4. The image stabilization system of claim 1, wherein the driving module further comprises a control circuit, the control circuit being configured for controlling a magnetic force generated between the first magnetic driving unit and the second magnetic driving unit.

5. The image stabilization system of claim 4, wherein the first magnetic driving unit comprises three electromagnetic members each comprising an upper portion, and a lower portion, the second magnetic driving unit comprises three magnet units each comprising an upper magnet spatially corresponding to the upper portion, and a lower magnet spatially corresponding to the lower portion.

6. The image stabilization system of claim 5, wherein a magnetic pole of the upper magnet facing a corresponding electromagnet member is opposite to a magnetic pole of the lower magnet facing the corresponding electromagnet member.

7. The image stabilization system of claim 4, wherein the control circuit comprises a processor and a driving circuit electrically connected to the processor, the processor is electrically connected to the motion sensor, and the driving circuit is electrically connected to the first magnetic driving unit.

8. The image stabilization system of claim 2, wherein the U-shaped magnetic shield is comprised of a material selected from the group consisting of ferronickel alloy, electrically conductive polymer, surface conductive material and electrically conductive glass.

9. The image stabilization system of claim 1, wherein the camera module comprises a lens module and an image sensor, the lens module optically aligned with the camera module, the image sensor being located at the image side of the lens module.
